(19) United States
(12) Patent Application Publication
(10) Pub. No.: US 2025/0378473 A1
(43) Pub. Date: Dec. 11, 2025

(54) TRANSACTION SUPPORT SYSTEM, TRANSACTION SUPPORT METHOD, AND RECORDING MEDIUM

(71) Applicant: NEC Corporation, Minato-ku, Tokyo (JP)

(72) Inventor: Yuya OSHIRO, Tokyo (JP)

(73) Assignee: NEC Corporation, Minato-ku, Tokyo (JP)

(21) Appl. No.: 18/876,820

(22) PCT Filed: Jul. 5, 2023
(86) PCT No.: PCT/JP2023/024856

§ 371 Date: Dec. 19, 2024

(30) Foreign Application Priority Data
Jul. 28, 2022 (JP) 2022-120670

(51) Int. Cl. G06Q 30/0601

(52) U.S. Cl. CPC G06Q 30/0601

(57) ABSTRACT

A transaction support system according to an aspect of the present disclosure includes: at least one memory storing instructions; and at least one processor configured to execute the instructions to acquire an image of an item to be listed, acquire information about the item to be listed based on the acquired image, determine, based on information about the item to be listed, whether the item to be listed matches a purchased product included in a purchase history of a product purchased by a listing person from a seller, and determine, whether the item to be listed can be listed on an e-commerce platform, based on a determination result of whether the item to be listed matches the purchased product.

### TECHNICAL FIELD

The present disclosure relates to a transaction support system and the like.

### BACKGROUND ART

E-commerce platforms in which a user can sell an article that the user no longer uses, an article that the user does not like, or the like to another user have become widespread. A user uses a user terminal such as a smartphone to transmit information about an article on such a platform, thereby listing the article.

PTL 1 discloses an information processing method capable of using an e-commerce platform with simple work. In PTL 1, when a user purchases a product at a member store, the payment terminal generates purchase information and transmits the purchase information to the mediation server. The mediation server receives, from the user terminal, a notification indicating that the e-commerce platform wishes to sell the product purchased at the merchant. When receiving a notification, the mediation server automatically generates the listing product information of the product based on the purchase information, and transmits the information to the user terminal.

### CITATION LIST

### Patent Literature

PTL 1: JP 2020-017068 A

### SUMMARY OF INVENTION

### Technical Problem

In a case where a transaction is performed on an e-commerce platform as in PTL 1, a user who purchases a product cannot confirm whether the source of the product listed by another user is certain. Therefore, the user may not be able to purchase the product with security.

An object of the present disclosure is to provide a transaction support system or the like that enhances reliability of a product to be listed by a user.

### Solution to Problem

A transaction support system according to the present disclosure includes: an image acquisition means for acquiring an image of an item to be listed; a determination means for, based on information about an item to be listed, which is based on the acquired image, and a purchase history of a product purchased by a listing person from a seller, determining whether the item to be listed matches a purchased product included in the purchase history; and a listing determination means for determining whether the item to be listed can be listed on an e-commerce platform, based on a determination result of whether the item to be listed matches the purchased product.

A transaction support method according to the present disclosure includes: acquiring an image of an item to be listed; determining, based on information about an item to be listed, which is based on the acquired image, and a purchase history of a product purchased by a listing person from a seller, whether the item to be listed matches a purchased product included in the purchase history; and determining whether the item to be listed can be listed on an e-commerce platform, based on a determination result of whether the item to be listed matches the purchased product.

A program according to the present disclosure causes a computer to execute: acquiring an image of an item to be listed; determining, based on information about an item to be listed, which is based on the acquired image, and a purchase history of a product purchased by a listing person from a seller, whether the item to be listed matches a purchased product included in the purchase history; and determining whether the item to be listed can be listed on an e-commerce platform, based on a determination result of whether the item to be listed matches the purchased product. The program may be stored in a non-transitory recording medium which can be computer-readable.

### Advantageous Effects of Invention

According to the present disclosure, it is possible to enhance reliability of a product to be listed by a user.

### BRIEF DESCRIPTION OF DRAWINGS

FIG. 1 is a diagram for explaining a configuration example of a transaction system according to a first example embodiment.

FIG. 2 is a block diagram illustrating a configuration example of a transaction support system according to the first example embodiment.

FIG. 3 is a flowchart illustrating an operation example of the transaction support system according to the first example embodiment.

FIG. 4 is a diagram illustrating an example of a photographing screen of an item to be listed.

FIG. 5 is a diagram illustrating an example of a display screen in a case where listing is permitted.

FIG. 6 is a block diagram illustrating a configuration example of a transaction support system according to a second example embodiment.

FIG. 7 is a flowchart illustrating an operation example of the transaction support system according to the second example embodiment.

FIG. 8 is a flowchart illustrating another operation example of the transaction support system according to the second example embodiment.

FIG. 9 is a block diagram illustrating a configuration example of a transaction support system according to a modification.

FIG. 10 is a diagram illustrating an example of a display screen of a listing price.

FIG. 11 is a block diagram illustrating an example of a hardware configuration of a computer.

### EXAMPLE EMBODIMENT

### First Example Embodiment

A transaction support system 100 according to a first example embodiment uses an image of an item to be listed and a purchase history of a product purchased by a listing person from a seller determine whether the item to be listed can be listed to an e-commerce platform. For example, the transaction support system 100 determines to permit the listing of the item to be listed in a case where the item to be listed matches the purchased product included in the purchase history. As a result, the transaction support system 100 determines to permit the listing of the purchased product in a case where it can be confirmed that the listing person holds the purchased product.

The seller is a vendor that operates a real shop or an online shop. The seller may be a vendor who sells a manufactured product or a planned product, or a vendor who purchases and sells a product including a used product. The sale of products by a seller may be referred to as primary distribution. A user using the e-commerce platform secondarily distributes a product by listing a product purchased from a seller. For example, the user lists the purchased product after using the product. Alternatively, the user may list the purchased product in an unused or unopened state.

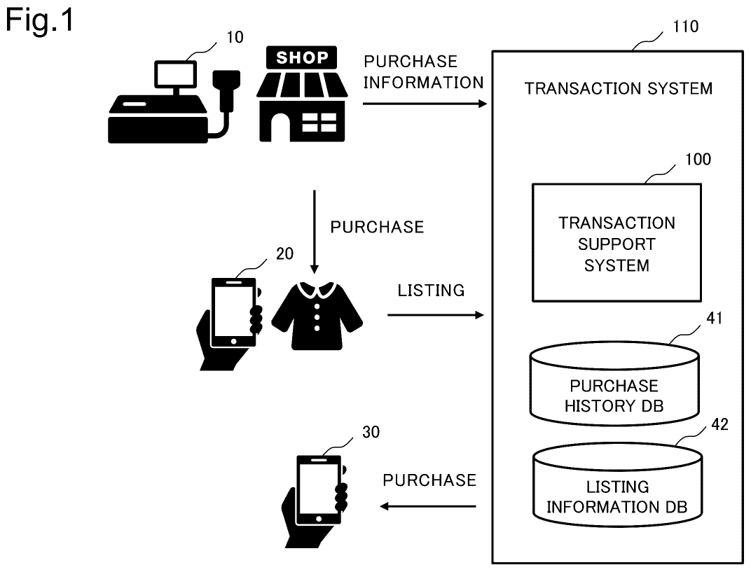

FIG. 1 is a diagram for explaining a configuration example of a transaction system 110 according to the first example embodiment. The transaction system 110 provides an e-commerce platform that achieves transaction of products between users. In the e-commerce platform, a transaction between a seller and a user may be performed.

In the first example embodiment, the e-commerce platform is provided by a seller having a purchase history of products sold to a customer. However, the e-commerce platform may be provided by a vendor separate from the seller. In this case, the seller provides the purchase history to the other vendors. In the first example embodiment, a case where only a product listed by a seller is listed on the e-commerce platform will be described. A case where a product other than the product listed by the seller is listed on the e-commerce platform will be described in a modification of the example embodiment.

The transaction system 110 of FIG. 1 includes a transaction support system 100, a purchase history database (DB) 41, and a listing information DB 42. However, the transaction support system 100 and the purchase history DB 41 may be achieved by a system separate from the transaction system 110. The transaction system 110 communicates with a point of sales (POS) system 10, a listing person terminal 20, and a purchaser terminal 30.

The POS system 10 manages information about a product sold by a seller to a customer. For example, the POS system 10 transmits the purchase information of the product sold to the customer to the transaction system 110.

The listing person terminal 20 is a terminal used by a listing person who lists a product on an e-commerce platform. The purchaser terminal 30 is a terminal used by a purchaser who considers purchasing a product listed on the e-commerce platform. Each of the listing person terminal 20 and the purchaser terminal 30 is, for example, a smartphone, a tablet, or a personal computer.

The purchase history DB 41 is a database that stores a purchase history of a product purchased by a customer from a seller. The purchase history DB 41 stores the purchase history based on the purchase information transmitted from the POS system 10. A product purchased from a seller by a customer is also referred to as a purchased product. The purchase history DB 41 manages a purchased product for each customer identifier (ID) for identifying a customer. The customer ID is associated with a listing person ID for identifying a listing person in the e-commerce platform.

The purchase history DB 41 stores a product ID for identifying a purchased product for each customer ID. The product ID is, for example, a code of a product (hereinafter, referred to as a product code). The product ID may be a product name. The product code is, for example, a Japanese Article Number (JAN) code, a European Article Number (EAN) code, or a Universal Product Code (UPC).

The purchase history DB 41 may further store an individual ID for identifying an individual of the purchased product. The individual ID is, for example, a serial number or a serial code attached to a product. The purchase history DB 41 may store an individual ID instead of the product ID.

The purchase history DB 41 may store a feature of a purchased product. The feature of the purchased product is a feature that allows the product to be distinguished from other products. The features of the purchased product are, for example, the shape and color of the product, and characters attached to the product. As the information indicating the feature of the purchased product, the purchase history DB 41 may store an image of the purchased product. The purchase history DB 41 may manage a feature of a purchased product for each product ID. The purchase history DB 41 may store an individual ID of a purchased product purchased by each customer as information indicating a feature of the purchased product.

The purchase history DB 41 may store the date when the customer purchases the purchased product and the purchase price of the purchased product based on the purchase information.

The listing information DB 42 is a database that stores information of a product listed by the listing person on the e-commerce platform for each listing person ID. For example, the listing information DB 42 stores a product listed by a customer as a listing person among purchased products purchased by the customer from a seller. The information of the product stored in the listing information DB 42 includes, for example, a product ID, an individual ID, or an image of the listed product. The listing information DB 42 may further store whether the product is being listed or sold.

A customer who has purchased a product from the seller lists an unnecessary product on the e-commerce platform. The customer who has purchased the product lists the product using the listing person terminal 20 as a listing person. At this time, the listing person terminal 20 photographs an image of the item to be listed. Then, the listing person terminal 20 transmits the captured image to the transaction support system 100. In one example, the listing person terminal 20 displays whether the item to be listed can be listed according to the control by the transaction support system 100.

A purchaser who considers purchasing a product browses the product listed on the e-commerce platform using the purchaser terminal 30. The product purchased by the purchaser is delivered from the listing person to the purchaser. The product may be delivered from the listing person to the purchaser via any intermediary.

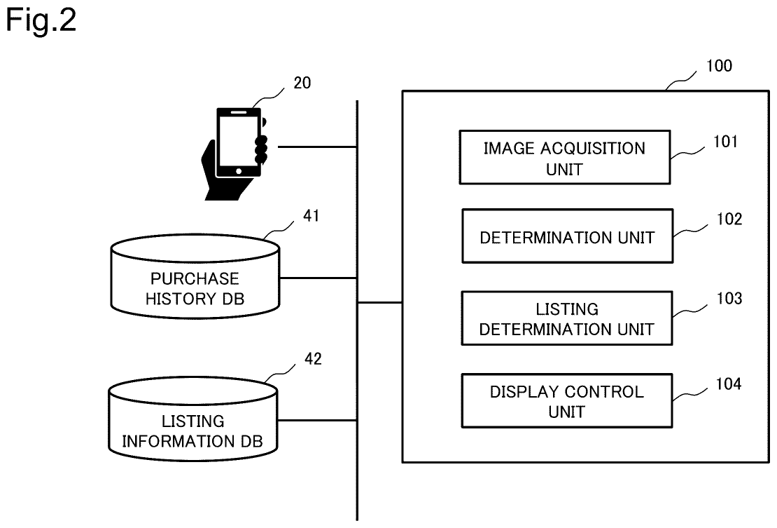

FIG. 2 is a block diagram illustrating a configuration example of the transaction support system 100 according to the first example embodiment. The transaction support system 100 includes an image acquisition unit 101, a determination unit 102, and a listing determination unit 103. The transaction support system 100 may further include a display control unit 104.

The image acquisition unit 101 acquires an image of the item to be listed. For example, the image acquisition unit 101 acquires an image obtained by photographing the item to be listed from the listing person terminal 20. The image of the item to be listed acquired by the image acquisition unit 101 is an image including a feature of the appearance of the item to be listed. The feature of the item to be listed includes, for example, the shape or color of the item or a character attached to the item. The feature of the appearance of the item to be listed included in the image may be a feature of a product specified by the same product ID or a feature for identifying an individual of each product. The feature for identifying the individual of the product is, for example, an individual ID attached to the product.

The image of the item to be listed may be an image obtained by photographing the entire item to be listed or an image obtained by photographing a part of the item to be listed. The listing person terminal 20 may photograph the region to which the individual ID is attached.

The determination unit 102 determines whether the item to be listed matches the purchased product included in the purchase history based on the information about the item to be listed based on the image of the item to be listed acquired by the image acquisition unit 101 and the purchase history of the product purchased by the listing person from the seller.

The information about the item to be listed based on the image is, for example, a feature of the appearance of the item to be listed recognized from the image. The determination unit 102 determines whether the feature of the appearance of the item to be listed is similar to the feature of the appearance of the purchased product. In a case where the similarity exceeds a threshold, the determination unit 102 determines that the item to be listed matches the purchased product. The determination unit 102 may determine that the item to be listed and the purchased product match in a case where the individual ID recognized from the image matches the individual ID of the purchased product. However, the determination method is not limited thereto.

The information about the item to be listed based on the image may be information about what product the product is, such as a product ID. The determination processing based on the information about the item to be listed and the purchase history will be described in more detail in a second example embodiment.

In a case where the image acquisition unit 101 acquires a plurality of images, the determination unit 102 may determine whether the item to be listed matches the purchased product by using the information about the item to be listed based on each of the plurality of images.

The listing determination unit 103 determines whether to allow the item to be listed to be listed on the e-commerce platform based on a determination result as to whether the item to be listed matches the purchased product of the listing person. For example, in a case where the item to be listed matches the purchased product, the listing determination unit 103 determines to permit the listing of the item to be listed. In the first example embodiment, the listing determination unit 103 determines to reject the listing of the item to be listed in a case where the item to be listed does not match the purchased product.

The listing determination unit 103 may store the product for which permission for listing on the e-commerce platform is determined in the listing information DB 42.

The display control unit 104 controls display on the listing person terminal 20. The display control unit 104 may display a screen requesting the listing person terminal 20 to capture an image of the item to be listed. When the display control unit 104 requests the listing person terminal 20 to capture an image, the image acquisition unit 101 can acquire an image of the item to be listed actually at the hand of the listing person.

The display control unit 104 may further display, on the listing person terminal 20, whether the listing determination unit 103 has permitted the listing of the item to be listed.

The display control unit 104 may further control displaying on the purchaser terminal 30.

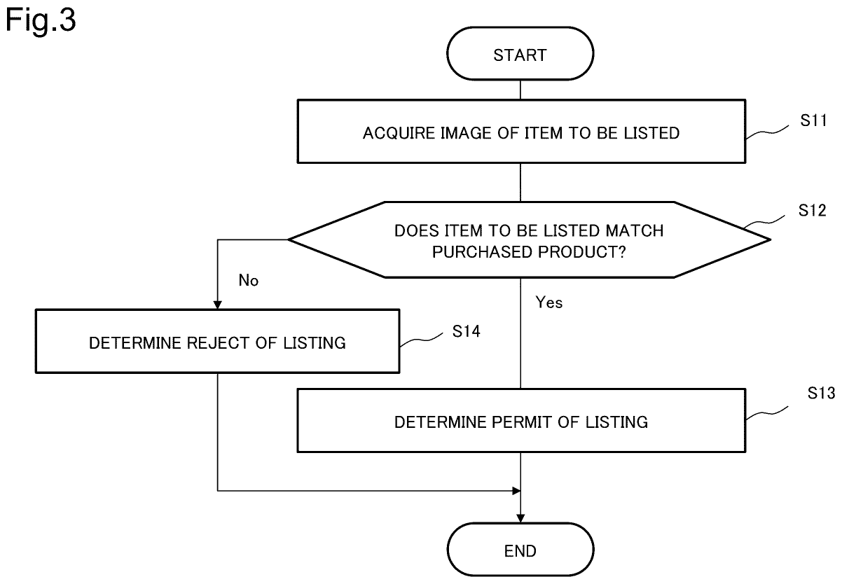

FIG. 3 is a flowchart illustrating an operation example of the transaction support system 100 according to the first example embodiment.

The image acquisition unit 101 acquires an image of an item to be listed (step S11). In step S11, the display control unit 104 may cause the listing person terminal 20 to display a photographing screen for requesting to capture an image of the item to be listed.

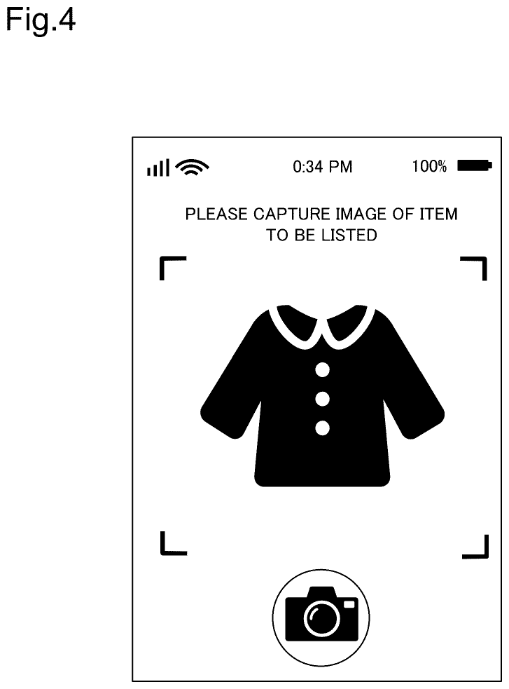

The listing person terminal 20 displays, for example, a photographing screen of the item to be listed illustrated in FIG. 4 according to the operation of the listing person. The listing person terminal 20 transmits the captured image of the item to be listed to the image acquisition unit 101.

The determination unit 102 determines whether the item to be listed matches the purchased product included in the purchase history based on the information about the item to be listed based on the image of the item to be listed acquired by the image acquisition unit 101 and the purchase history of the product purchased by the listing person from the seller (step S12).

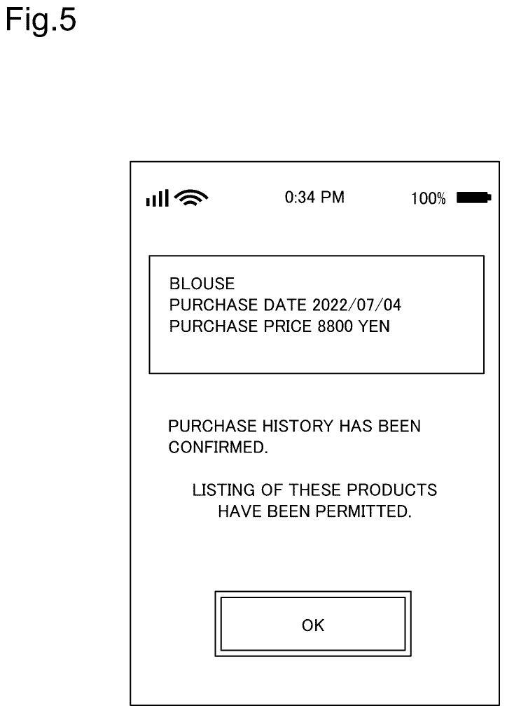

In a case where the item to be listed matches the purchased product (step S12; Yes), the listing determination unit 103 determines to permit the listing of the item to be listed (step S13). In this case, the display control unit 104 may display that the listing is permitted. FIG. 5 is a diagram illustrating an example of a display screen of the listing person terminal 20 in a case where the listing of the item to be listed is permitted. As illustrated in FIG. 5, the display control unit 104 may display the purchase date and the purchase price of the purchased product stored in the purchase history DB 41.

In a case where the item to be listed does not match the purchased product (step S12; No), the listing determination unit 103 determines to reject the listing of the item to be listed (step S14). In this case, the display control unit 104 may display that the listing is rejected. In addition to this, the display control unit 104 may display the reason why the listing is rejected. For example, the display control unit 104 displays that the photographed item to be listed has not been purchased from the seller as the reason why the listing is rejected.

Thus, the description of the operation example of the transaction support system 100 according to the first example embodiment ends.

According to the first example embodiment, the image acquisition unit 101 acquires the image of the item to be listed. The determination unit 102 determines whether the item to be listed matches the purchased product included in the purchase history based on the information about the item to be listed based on the image of the item to be listed and the purchase history of the product purchased by the listing person from the seller. Further, the listing determination unit 103 determines whether the item to be listed can be listed on the e-commerce platform. Whether to allow listing is determined according to whether the listing person has purchased the item to be listed in the past, so that the certainty of the source of the listed product is increased. Therefore, the reliability of the product listed by the user on the e-commerce platform can be enhanced. For example, listing of imitation products or stolen products not purchased from a seller is not permitted. Thus, the user of the e-commerce platform may purchase a trusted secondary or used product.

According to the first example embodiment, the listing is rejected in a case where the listing person cannot photograph the image of the item to be listed, such as a case where the listing person does not hold the item to be listed. Therefore, the purchaser can purchase a product guaranteed to be available for sale.

In a case where the products sold by the seller are secondarily distributed on a platform not involving the seller, the seller will not benefit. According to the first example embodiment, an e-commerce platform is provided by a seller with a purchase history. Therefore, the transaction is performed on a reliable platform provided by the seller. The seller may benefit from commission or the like.

### Second Example Embodiment

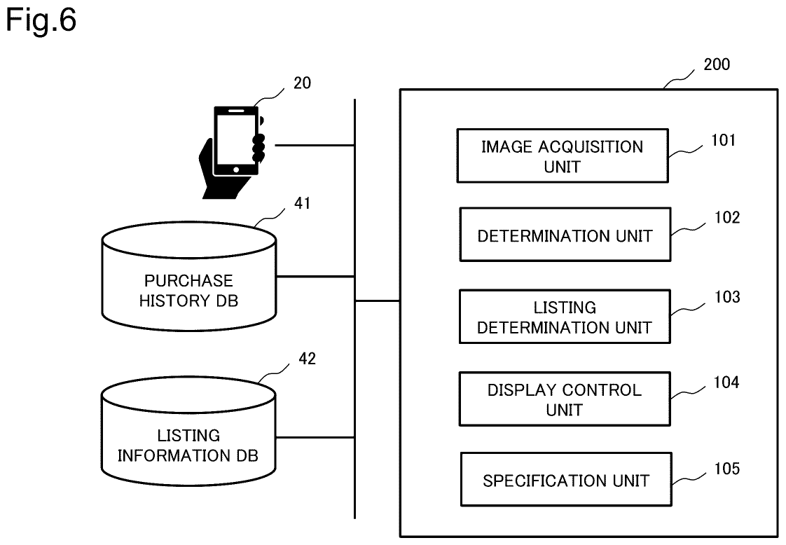

FIG. 6 is a block diagram illustrating a configuration example of a transaction support system 200 according to a second example embodiment. The transaction support system 200 according to the second example embodiment is different from the transaction support system 100 according to the first example embodiment in including a specification unit 105. Regarding the configuration according to the second example embodiment, detailed description of the same configuration as that of the first example embodiment will be omitted.

The specification unit 105 specifies what product the item to be listed is. Then, the determination unit 102 determines whether the item to be listed specified by the specification unit 105 matches the purchased product included in the purchase history.

The specification unit 105 may specify which product the item to be listed is among the products handled by the seller. Alternatively, the specification unit 105 specifies which product is the item to be listed among the purchased products purchased by the listing person from the seller.

For example, the specification unit 105 specifies a product ID including a product name and a product code of an item to be listed to specify the item to be listed.

The specification unit 105 may specify the product ID based on the information for specifying the item to be listed by the listing person. The information for specifying the item to be listed is not particularly limited as long as it is information input for specifying the product ID.

For example, the specification unit 105 receives an input of a keyword related to the item to be listed from the listing person terminal 20 as information for specifying the item to be listed. The keyword related to the item to be listed includes, for example, a product name, a product code, or a product type. At this time, the display control unit 104 displays the input field of the keyword related to the item to be listed on the listing person terminal 20. Then, the specification unit 105 searches for the product by the received keyword and specifies the product ID of the item to be listed.

The specification unit 105 may receive selection of a product from the list of products as the information for specifying the item to be listed. The list of products is, for example, a list of products handled by the seller or a list of purchased products purchased from the seller by the listing person. The display control unit 104 may display the list of products on the listing person terminal 20. Then, the specification unit 105 specifies the product ID of the product selected from the displayed list of products.

Alternatively, the specification unit 105 receives an input of an image of the item to be listed as information for specifying the item to be listed. The specification unit 105 may specify the product ID based on the image of the item to be listed acquired by the image acquisition unit 101. Then, the specification unit 105 specifies the product ID by performing image recognition on the image of the item to be listed.

As described in the first example embodiment, the determination unit 102 determines whether the item to be listed matches the purchased product of the listing person based on the information about the item to be listed based on the image of the item to be listed and the purchase history. In one example, the determination unit 102 determines whether the feature of the item to be listed included in the image of the item to be listed matches the feature of the purchased product. In another example, the determination unit 102 determines whether a purchased product matching a product specified based on the image of the item to be listed is included in the purchase history of the listing person.

First, a case will be described in which the determination unit 102 determines whether the item to be listed matches the purchased product depending on whether the feature of the item to be listed included in the image of the item to be listed matches the feature of the purchased product. The feature of the item to be listed is an example of information about the item to be listed based on the image of the item to be listed.

The determination unit 102 refers to the purchase history DB 41, and searches for a purchased product whose product ID matches the product ID specified by the specification unit 105. The determination unit 102 acquires the feature of the purchased product for the searched product. In a case where the feature of the item to be listed included in the image of the item to be listed matches the feature of the purchased product, the determination unit 102 determines that the item to be listed matches the purchased product. In a case where the similarity between the image of the item to be listed and the image of the purchased product exceeds a predetermined threshold, the determination unit 102 may determine that the feature of the item to be listed matches the feature of the purchased product. However, the determination method is not limited thereto.

The determination unit 102 may determine whether the item to be listed matches the purchased product based on the feature of the product specified by the product ID. The determination unit 102 may determine whether the item to be listed matches the purchased product based on the feature for identifying the individual product. For example, the determination unit 102 searches the purchase history DB 41 for a purchased product having a product ID matching the specified product ID. The determination unit 102 acquires an individual ID for the searched purchased product. Then, the determination unit 102 determines whether the individual ID recognized from the image matches the individual ID included in the purchase history DB 41. The determination unit 102 may perform the determination by the individual ID after the determination by the feature of the appearance of the product specified by the product ID.

The determination unit 102 may switch whether to determine whether the item to be listed matches the purchased product using the individual ID according to the product. Depending on the type of the product, the individual ID may not be attached. Therefore, the determination unit 102 may refer to a database and determine whether the specified item to be listed is a product to which the individual ID is attached. For example, the determination unit 102 refers to a database that stores whether a product is a product to which an individual ID is attached for each type of product or each product ID. The determination unit 102 performs determination using the individual ID for the product to which the individual ID is attached. For a product to which an individual ID is not attached, the determination unit 102 makes a determination using the product ID or the feature of the appearance of the product specified by the product ID.

Next, a case where the determination unit 102 determines whether a purchased product matching the product of the item to be listed specified by the specification unit 105 is included in the purchase history of the listing person will be described.

The determination unit 102 refers to the purchase history DB 41 and determines whether there is a product ID of a purchased product matching the product ID specified by the specification unit 105 based on the image of the item to be listed. The product ID here is an example of information about the item to be listed based on the image of the item to be listed. In a case where there is the product ID of the purchased product matching the product ID of the item to be listed in the purchase history, the determination unit 102 determines that the item to be listed matches the purchased product. At this time, the determination unit 102 may not collate the image of the item to be listed with the image of the purchased product.

As described above, the determination unit 102 determines whether the item to be listed matches the purchased product based on the information about the item to be listed based on the image of the item to be listed and the purchase history. However, the method of determination by the determination unit 102 is not limited to the above example.

The determination unit 102 may determine whether the item to be listed is included in the purchase history based on the product ID of the item to be listed before performing the determination using the image of the item to be listed. In a case where the product ID specified by the specification unit 105 is not included in the purchase history, the listing determination unit 103 determines to reject the listing of the item to be listed. In this case, the determination unit 102 stops the process of collating the features of the appearance of the item to be listed using the image of the item to be listed.

The image acquisition unit 101 may acquire the image of the item to be listed in a case where the purchased product matching the specified product is searched by the determination unit 102. Accordingly, in a case where the specified product is not included in the purchase history, the image acquisition unit 101 does not acquire the image of the item to be listed. Therefore, it is possible to prevent acquisition of an unnecessary image.

However, the timing at which the image acquisition unit 101 acquires the image is not limited thereto. The specification unit 105 may specify what product the item to be listed is in a case where the image acquisition unit 101 acquires the image. As a result, the specification unit 105 starts the processing in a case where the image of the item to be listed can be captured. Therefore, it is possible to prevent unnecessary processing in a case where the product cannot be listed, such as a case where the item to be listed is not at hand of the listing person.

In a case where the specification unit 105 cannot specify the item to be listed, the listing determination unit 103 determines to reject the listing of the item to be listed.

Hereinafter, an operation example of the transaction support system 200 according to the second example embodiment will be described.

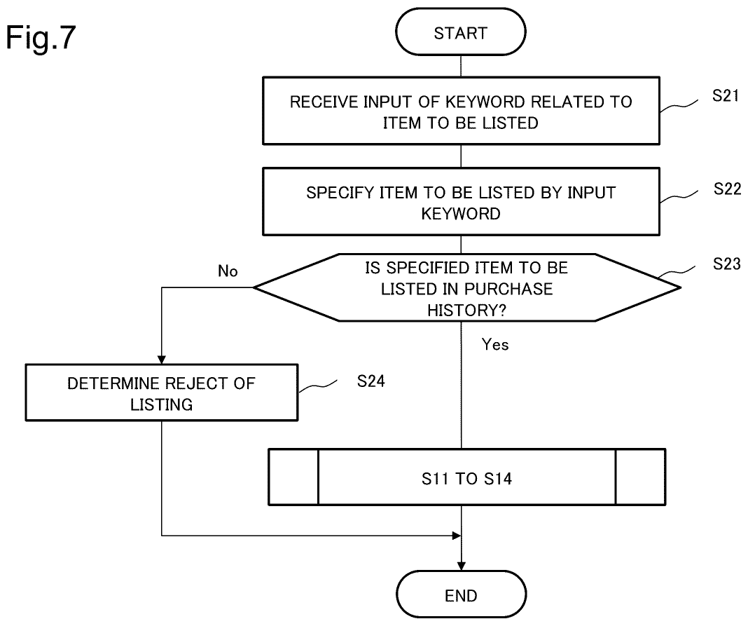

FIG. 7 is a flowchart illustrating an operation example of the transaction support system 200 according to the second example embodiment. FIG. 7 illustrates an operation example in a case where the listing person captures an image of the item to be listed after inputting the information for specifying the item to be listed.

The specification unit 105 receives an input of a keyword related to the item to be listed as information for specifying the item to be listed (step S21). Then, the specification unit 105 specifies the product ID of the item to be listed by the input keyword (step S22).

The determination unit 102 determines whether the specified item to be listed is included in the purchase history based on the specified product ID (step S23).

In a case where the specified item to be listed is included in the purchase history (step S23; Yes), the transaction support system 200 performs a process similar to that in FIG. 3 of the transaction support system 100 according to the first example embodiment. That is, the transaction support system 200 performs the same processing as steps S11 to S14 in FIG. 3.

Specifically, in a case where the specified item to be listed is included in the purchase history, the image acquisition unit 101 acquires an image of the item to be listed (step S11). Thereafter, the determination unit 102 determines whether the item to be listed matches the purchased product based on the image of the item to be listed and the purchase history (step S12). For example, the determination unit 102 determines whether the item to be listed matches the purchased product according to whether the feature of the item to be listed indicated by the image of the item to be listed matches the feature of the purchased product.

By executing the processing of step S11 after step S23, it is possible to prevent the image from being acquired even though the item to be listed is not included in the purchase history.

In a case where the item to be listed matches the purchased product (step S12; Yes), the listing determination unit 103 determines to permit the listing of the item to be listed (step S13). In a case where the item to be listed does not match the purchased product (step S12; No), the listing determination unit 103 determines to reject the listing of the item to be listed (step S14).

In a case where the specified product is not included in the purchase history (step S23; No), the listing determination unit 103 determines to reject the listing of the item to be listed (step S24). The display control unit 104 causes the listing person terminal 20 to display that there is no purchase history of the item to be listed as the reason why the listing is rejected.

The operation example of FIG. 7 is an example, and the image acquisition unit 101 may acquire the image of the item to be listed before the keyword related to the item to be listed is received by executing step S11 before step S21. In a case where the image is acquired, the specification unit 105 specifies the product, so that it is possible to prevent execution of the process of specifying the product in a case where the image cannot be acquired.

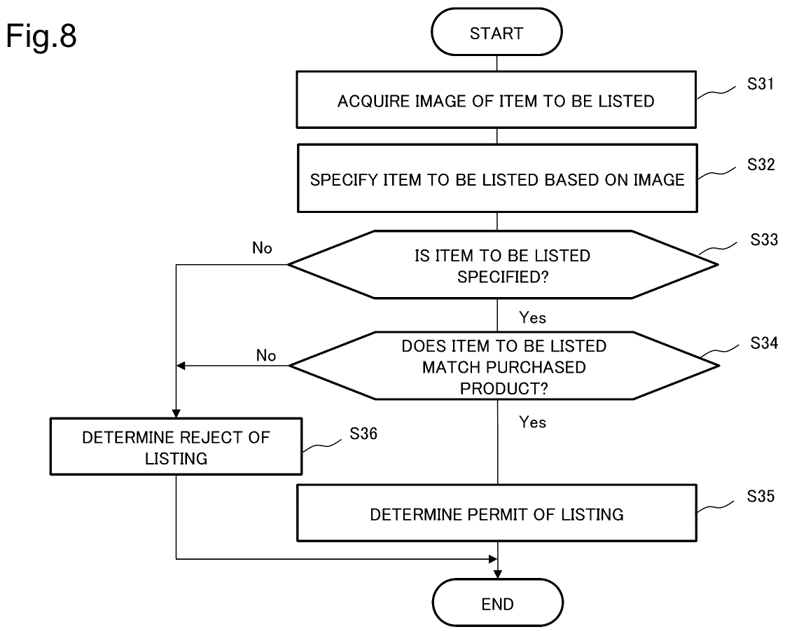

FIG. 8 is a flowchart illustrating another operation example of the transaction support system 200 according to the second example embodiment. FIG. 8 illustrates an operation example in a case where the item to be listed is specified based on the image of the item to be listed.

In FIG. 8, the image acquisition unit 101 acquires an image of the item to be listed (step S31). Then, the specification unit 105 specifies what product the planned product is based on the image of the item to be listed acquired by the image acquisition unit 101 (step S32). The specification unit 105 specifies which product the item to be listed is among the products handled by the seller. Then, the specification unit 105 acquires the product ID of the specified product.

In a case where the item to be listed is not specified based on the image of the item to be listed (Step S33: No), the listing determination unit 103 determines to reject the listing of the item to be listed (Step S36).

In a case where the item to be listed is specified based on the image of the item to be listed (step S33: Yes), the determination unit 102 determines whether the specified item to be listed matches the purchased product (step S34). For example, in step S34, the determination unit 102 refers to the purchase history DB 41 and determines whether there is a product ID of a purchased product matching the specified product ID. Alternatively, in step S34, the determination unit 102 refers to the purchase history DB 41 and determines whether the individual ID of the purchased product having the specified product ID matches the individual ID of the item to be listed.

In a case where the item to be listed matches the purchased product (step S34; Yes), the listing determination unit 103 determines to permit the listing of the item to be listed (step S35). In a case where the item to be listed does not match the purchased product (step S34; No), the listing determination unit 103 determines to reject the listing of the item to be listed (step S36).

As described above, the transaction support system 200 ends the operation of FIG. 8.

According to the second example embodiment, the specification unit 105 specifies what product the item to be listed is. Then, the determination unit 102 determines whether the specified item to be listed matches the purchased product. As a result, the determination targets by the determination unit 102 are narrowed down. For example, the determination unit 102 does not need to collate the features of the products based on the image for all the purchased products included in the purchase history. Therefore, the load of the determination processing by the determination unit 102 can be reduced.

### Modifications

The transaction support systems 100 and 200 according to the example embodiments can be modified as follows, for example.

In the first example embodiment, the determination unit 102 may search the purchase history DB 41 for the purchased product having the feature matching the feature of the item to be listed. In a case where the purchased product having the feature matching the feature of the item to be listed is searched, the determination unit 102 determines that the item to be listed matches the purchased product.

In one modification, the listing determination unit 103 may further determine whether to perform listing of the item to be listed based on the listing history of the purchased product of the listing person. For example, the listing determination unit 103 may determine to reject overlapping listing of the item to be listed based on the listing history of the listing person.

The listing determination unit 103 refers to the listing information DB 42 of the listing person, for example, and determines to permit listing of the item to be listed in a case where the item to be listed is not yet listed. In a case where the listing person has already listed the item to be listed, the listing determination unit 103 determines to reject the listing of the item to be listed. As a result, it is possible to prevent a product not owned by the listing person from being listed. It is possible to prevent overlapping listing.

In a case where the individual products specified by the same product ID are not distinguished, the listing determination unit 103 may determine whether the item to be listed can be listed such that the total number of the listed purchased products and the products scheduled to be listed does not exceed the number of the purchased products stored in the purchase history DB 41.

The listing determination unit 103 may determine to reject the listing of an expensive product based on the listing history. For example, the listing determination unit 103 rejects the listing of an expensive product assuming that the listing person whose past number of listing items is smaller than a predetermined number is a caution-needed listing person. The listing determination unit 103 may determine to permit the listing of an expensive product assuming that the listing person whose past number of listing items is larger than a predetermined number is an excellent listing person.

The listing determination unit 103 may acquire a desired listing price desired by the listing person from the listing person terminal 20, and determine to permit listing in a case where the desired listing price is acquired within an upper limit or a lower limit of a preset price. In a case where the upper limit of the price is set, for example, the listing determination unit 103 determines to permit the listing when the desired listing price is equal to or less than the fixed price. As a result, it is possible to prevent expensive resale of the product. In a case where the lower limit of the price is set, the seller can prevent resale at an excessively low price, thereby preventing a decrease in the brand value of the product.

In one modification, the listing determination unit 103 may determine to permit the listing even in a case where the item to be listed does not match the purchased product. That is, the e-commerce platform may list products for which the listing person is not proven to have purchased from the seller. For example, a product purchased by a listing person from another seller who does not provide a purchase history may be listed. At this time, the display control unit 104 causes the purchaser terminal 30 to display whether the listed product has been purchased from a seller. As a result, the purchaser can determine whether to purchase the product in consideration of whether the product listed by the user is reliable.

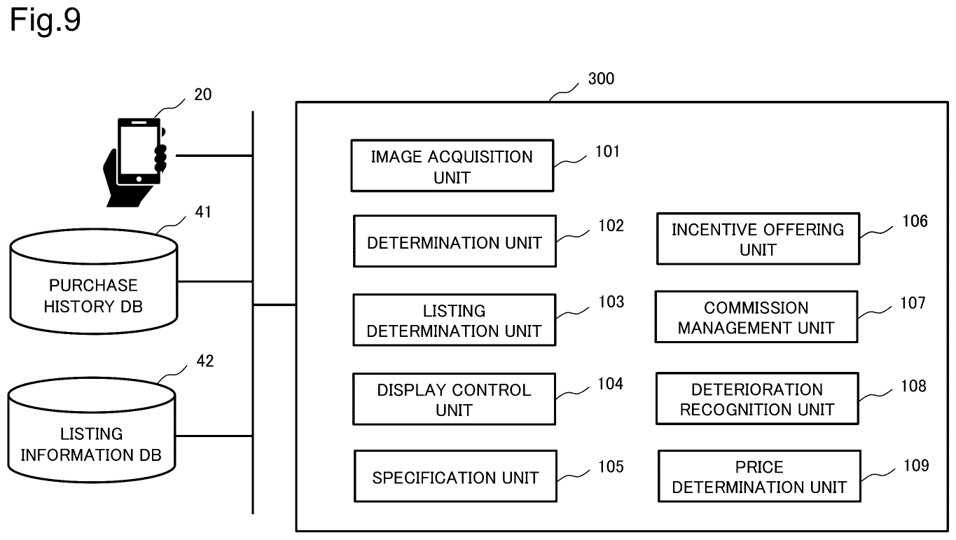

FIG. 9 is a block diagram illustrating a configuration example of a transaction support system 300 of a modification. The transaction support system 300 is different from the transaction support system 200 according to the second example embodiment in including an incentive offering unit 106, a commission management unit 107, a deterioration recognition unit 108, and a price determination unit 109. In the present modification, description of configurations similar to those of the first example embodiment and the second example embodiment will be omitted. The incentive offering unit 106, the commission management unit 107, the deterioration recognition unit 108, and the price determination unit 109 may be provided as necessary.

The incentive offering unit 106 offers an incentive usable for purchase of a product from a seller to a listing person who is permitted to sell the purchased product purchased from the seller. By offering an incentive to the listing person, an incentive to perform secondary distribution on a platform provided by the seller is given to the listing person, not on other platforms. It is expected that the listing person becomes a customer who repeatedly purchases from the seller by offering an incentive that can be used to purchase a product from the seller.

The commission management unit 107 manages a commission paid by the listing person or the purchaser to the seller. For example, in a case where a listed product is purchased, the commission management unit 107 charges a commission from the listing person or the purchaser. According to the commission management unit 107, the seller can obtain an appropriate commission. Therefore, even in a case where the product is secondarily distributed, the seller can obtain a profit.

The deterioration recognition unit 108 recognizes deterioration of the item to be listed from the image of the item to be listed. For example, the deterioration recognition unit 108 may recognize the deterioration of the item to be listed based on the image acquired by the image acquisition unit 101.

For example, the deterioration recognition unit 108 recognizes whether there is a scratch or stain on the item to be listed. The deterioration recognition unit 108 may recognize the deteriorated portion by comparing the image of the item to be listed with the image of the purchased product. The display control unit 104 causes the listing person terminal 20 to display information indicating the deterioration recognized by the deterioration recognition unit 108.

For example, the deterioration recognition unit 108 represents the recognized deterioration by a deterioration degree. The deterioration degree of the item to be listed may be represented by a plurality of stages. For example, the deterioration degree may be expressed as a new product, a nearly unused product, no conspicuous scratches or stains, scratches or stains, or an overall poor state. The deterioration degree may be represented by a score.

The price determination unit 109 determines the listing price according to a result of the deterioration recognition unit 108 recognizing the deterioration. For example, the price determination unit 109 determines the listing price lower as the deterioration degree is higher. The price determination unit 109 may further determine the listing price according to the time elapsed from the purchase date. For example, the price determination unit 109 determines the price lower as the time elapsed from the purchase date is longer. The price determination unit 109 may determine the price higher as the elapsed time is longer.

The display control unit 104 causes the listing person terminal 20 to display the listing price determined by the price determination unit 109. The price determination unit 109 may receive correction of the determined listing price from the listing person terminal 20.

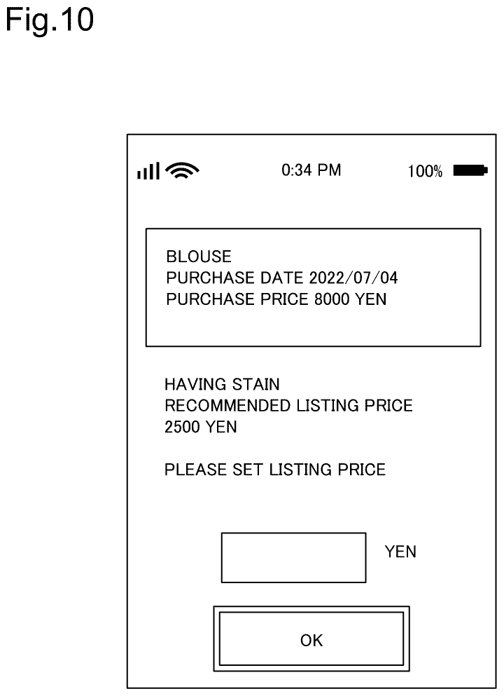

FIG. 10 is a diagram illustrating an example of a display screen of a listing price. The screen of FIG. 10 displays the recommended listing price determined by the price determination unit 109. The screen of FIG. 10 includes a display indicating that the deterioration recognition unit 108 has recognized the stain and a field for inputting the desired listing price of the listing person. The price determination unit 109 corrects the determined listing price according to the desired listing price input by the listing person.

The display control unit 104 may display the screen of FIG. 10 after displaying the screen illustrated in FIG. 5. Alternatively, the display control unit 104 may display the contents illustrated in FIG. 5 and the contents illustrated in FIG. 10 on one screen.

### [Hardware Configuration]

In the above-described example embodiment, each component of the transaction support systems 100, 200, and 300 represents a block of functional units. A part or all of each component of the transaction support systems 100, 200, and 300 may be achieved by any combination of a computer 500 and a program.

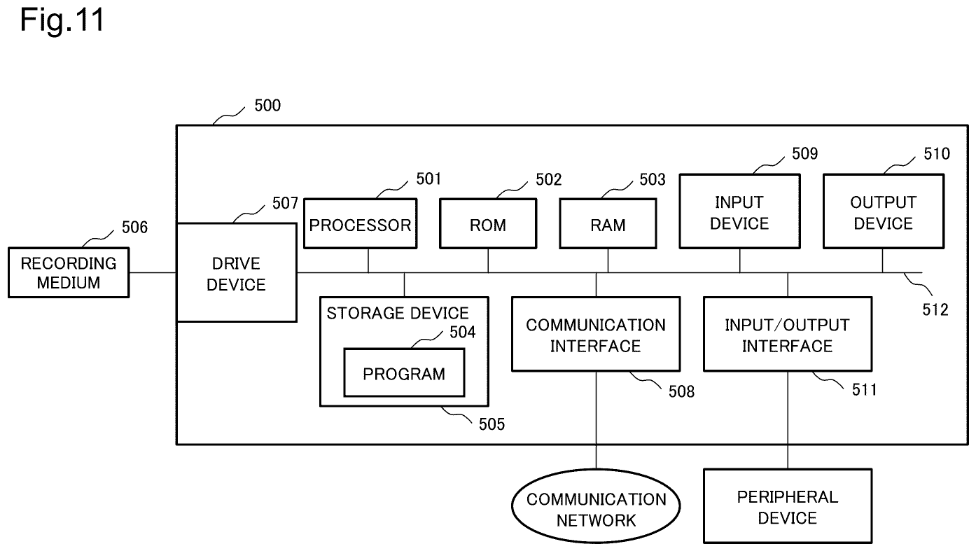

FIG. 11 is a block diagram illustrating an exemplary hardware configuration of the computer 500. Referring to FIG. 11, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the transaction support systems 100, 200, and 300. The program 504 is stored in advance in the ROM 502, the RAM 503, and the storage device 505. The processor 501 implements the functions of the transaction support systems 100, 200, and 300 by executing instructions included in the program 504. The RAM 503 may store data to be processed in each function of the transaction support system 100.

The drive device 507 reads and writes a recording medium 506. The communication interface 508 provides an interface with a communication network. The input device 509 is, for example, a mouse, a keyboard, or the like, and receives an input of information from an administrator or the like of the transaction support system 100. The output device 510 is, for example, a display, and outputs (displays) information to an administrator or the like. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 11 is an example, and other components may be added or some components may not be included.

There are various modifications of the method for implementing the transaction support system 100, 200, and 300. For example, the transaction support systems 100, 200, and 300 may be achieved by an arbitrary combination of a computer and a program different for each component. A plurality of components included in the transaction support system 100, 200, and 300 may be achieved by any combination of one computer and a program.

At least a part of the transaction support system 100, 200, and 300 may be provided in a software as a service (SaaS) format. That is, at least a part of the functions for achieving the transaction support systems 100, 200, and 300 may be executed by software executed via a network.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

This application is based upon and claims the benefit of priority from Japanese patent application No. 2022-120670, filed on Jul. 28, 2022, the disclosure of which is incorporated herein in its entirety by reference.

Some or all of the above example embodiments may be described as the following Supplementary Notes, but are not limited to the following.

### SUPPLEMENTARY NOTES

### Supplementary Note 1

A transaction support system including:
an image acquisition means for acquiring an image of an item to be listed;
a determination means for, based on information about an item to be listed, which is based on the acquired image, and a purchase history of a product purchased by a listing person from a seller, determining whether the item to be listed matches a purchased product included in the purchase history; and
a listing determination means for determining whether the item to be listed can be listed on an e-commerce platform, based on a determination result of whether the item to be listed matches the purchased product.

### Supplementary Note 2

The transaction support system according to Supplementary Note 1, further including:
a specification means for specifying what product the item to be listed is based on information for specifying the item to be listed, wherein
the determination means determines whether the specified item to be listed matches the purchased product.

### Supplementary Note 3

The transaction support system according to Supplementary Note 2, in which
the specification means specifies what product the item to be listed is based on information for specifying the item to be listed including at least a product name or a product code,
the determination means searches whether the purchased product matching the specified product is included in the purchase history, and determines whether the item to be listed matches the purchased product based on whether a feature of the item to be listed based on the image matches a feature of the searched purchased product, and
the image acquisition means acquires the image in a case where the purchased product matching the specified product is searched.

### Supplementary Note 4

The transaction support system according to Supplementary Note 2, in which
the specification means specifies what product the item to be listed is based on information for specifying the item to be listed including at least a product name or a product code in a case where the image is acquired, and
the determination means searches whether the purchased product matching the specified product is included in the purchase history, and determines whether the item to be listed matches the purchased product based on whether a feature of the item to be listed based on the image matches a feature of the searched purchased product.

### Supplementary Note 5

The transaction support system according to Supplementary Note 2, in which
the specification means specifies what product the item to be listed is based on information for specifying the item to be listed including at least the image, and
the determination means determines whether the item to be listed matches the purchased product according to whether the purchased product matching the specified product is included in the purchase history.

### Supplementary Note 6

The transaction support system according to any one of Supplementary Notes 1 to 5, in which
the listing determination means further determines to reject overlapping listing of the item to be listed based on a listing history of the purchased product of the listing person.

### Supplementary Note 7

The transaction support system according to any one of Supplementary Notes 1 to 5, including:
an incentive offering means for providing an incentive usable for purchase of a product from the seller to the listing person who is permitted to list the purchased product purchased from the seller.

### Supplementary Note 8

The transaction support system according to any one of Supplementary Notes 1 to 5, including:
a deterioration recognition means for recognizing deterioration of the item to be listed from the image; and
a price determination means for determining a listing price according to a result of recognizing the deterioration.

### Supplementary Note 9

A transaction support method including:
acquiring an image of an item to be listed;
determining, based on information about an item to be listed, which is based on the acquired image, and a purchase history of a product purchased by a listing person from a seller, whether the item to be listed matches a purchased product included in the purchase history; and
determining whether the item to be listed can be listed on an e-commerce platform, based on a determination result of whether the item to be listed matches the purchased product.

### Supplementary Note 10

A program causing a computer to execute:
acquiring an image of an item to be listed;
determining, based on information about an item to be listed, which is based on the acquired image, and a purchase history of a product purchased by a listing person from a seller, whether the item to be listed matches a purchased product included in the purchase history; and
determining whether the item to be listed can be listed on an e-commerce platform, based on a determination result of whether the item to be listed matches the purchased product.

### REFERENCE SIGNS LIST

110 transaction system
100, 200, 300 transaction support system
101 image acquisition unit
102 determination unit
103 listing determination unit
104 display control unit
105 specification unit
106 incentive offering unit
107 commission management unit
108 deterioration recognition unit
109 price determination unit
20 listing person terminal
30 purchaser terminal
41 purchase history DB
42 listing information DB

What is claimed is:

1. A transaction support system comprising:
at least one memory storing instructions; and
at least one processor configured to execute the instructions to:
acquire an image of an item to be listed;
acquire information about the item to be listed based on the acquired image;
determine, based on information about the item to be listed, whether the item to be listed matches a purchased product included in a purchase history of a product purchased by a listing person from a seller; and
determine, whether the item to be listed can be listed on an e-commerce platform, based on a determination result of whether the item to be listed matches the purchased product.

2. The transaction support system according to claim 1, wherein the at least one processor is further configured to execute the instructions to:
specify what product the item to be listed is based on information for specifying the item to be listed; and
determine whether the specified item to be listed matches the purchased product.

3. The transaction support system according to claim 2, wherein the at least one processor is further configured to execute the instructions to:
specify what product the item to be listed is based on information for specifying the item to be listed including at least a product name or a product code,
search whether the purchased product matching the specified product is included in the purchase history;
perform acquiring of the image in a case where the purchased product matching the specified product is searched; and
determine whether the item to be listed matches the purchased product based on whether a feature of the item to be listed based on the image matches a feature of the searched purchased product.

4. The transaction support system according to claim 2, wherein the at least one processor is further configured to execute the instructions to:
specify what product the item to be listed is based on information for specifying the item to be listed including at least a product name or a product code in a case where the image is acquired, and
search whether the purchased product matching the specified product is included in the purchase history;
determine whether the item to be listed matches the purchased product based on whether a feature of the item to be listed based on the image matches a feature of the searched purchased product.

5. The transaction support system according to claim 2, wherein the at least one processor is further configured to execute the instructions to:
specify what product the item to be listed is based on information for specifying the item to be listed including at least the image, and
determine whether the item to be listed matches the purchased product according to whether the purchased product matching the specified product is included in the purchase history.

6. The transaction support system according to claim 1, wherein the at least one processor is further configured to execute the instructions to:
reject overlapping listing of the item to be listed based on a listing history of the purchased product of the listing person.

7. The transaction support system according to claim 1, wherein the at least one processor is further configured to execute the instructions to:
offer an incentive usable for purchase of a product from the seller to the listing person who is permitted to list the purchased product purchased from the seller.

8. The transaction support system according to claim 1, wherein the at least one processor is further configured to execute the instructions to:
recognize deterioration of the item to be listed from the image; and
determine a listing price according to a result of recognizing the deterioration.

9. A transaction support method comprising:
acquiring an image of an item to be listed;
acquiring information about the item to be listed based on the acquired image;
determining, based on information about the item to be listed, whether the item to be listed matches a purchased product included in a purchase history of a product purchased by a listing person from a seller; and
determining whether the item to be listed can be listed on an e-commerce platform, based on a determination result of whether the item to be listed matches the purchased product.

10. A non-transitory recording medium having stored therein a program causing a computer to execute:
acquiring an image of an item to be listed;
acquiring information about the item to be listed based on the acquired image;
determining, based on information about the item to be listed, whether the item to be listed matches a purchased product included in the purchase history of a product purchased by a listing person from a seller; and
determining whether the item to be listed can be listed on an e-commerce platform, based on a determination result of whether the item to be listed matches the purchased product.
